(19) United States
(12) Patent Application Publication
(10) Pub. No.: US 2007/0034064 A1
(43) Pub. Date: Feb. 15, 2007

(54) Dust-collecting unit and electric tool having the same

(76) Inventors: Tomomasa Nishikawa, Hitachinaka-shi (JP); Kenichi Matsunaga, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/502,438

(22) Filed: Aug. 11, 2006

(30) Foreign Application Priority Data
Aug. 12, 2005 (JP) P2005-234575

(51) Int. Cl. B26D 7/06

(52) U.S. Cl. 83/100

(57) ABSTRACT

The present invention provides a dust collection unit usable with an electric tool having an electric motor, an end tool driven by the electric motor, and a cover partially covering the end tool and having a residue discharge port. The dust collection unit is detachably communicable with the residue discharge port. The dust collection unit has a main casing, lid means, and a handle. The main casing is configured to accommodate dust and residues therein. The main casing has an opening. The lid means opens and closes the opening. The handle is provided in proximity to the lid means on the main casing.

### BACKGROUND OF THE INVENTION

1. Technical Field

The present invention relates to a dust collection unit and an electric tool having the dust collection unit.

2. Related Art

Some of electric circular saws for cutting a workpiece such as a wooden piece have a dust collection unit that collects and accommodates chips and residues generated when the workpiece is cut. Japanese Patent Publication 2005-022338 discloses an electric circular saw having a dust collection unit, as shown in FIG. 1. The electric circular saw 210 includes a housing 213, a saw blade 214, and a base 215. The housing 213 contains an electric motor (not shown) The saw blade 214 is rotated by the electric motor. The base 215 is coupled to the housing 213 and slides on a workpiece 216 so that the saw blade 214 cuts the workpiece 216. The electric circular saw 210 has a dust collection unit 201 that is detachable thereto.

The dust collection unit 201 is provided to collect chips and residues generated when the saw blade 214 cuts the workpiece 216. The collection unit 201 has a coupling part 203, a holding part 206, and a box part 205. The coupling part 203 has a hollow cylindrical shape. The box part 205 has a plurality of windows 205a made by cutting. The box part 205 contains a bag 230. The bag 230 is made of Japanese paper or a filter member of synthetic fiber. The bag 230 has a mesh that allows only air to pass therethrough.

The dust collection unit 201 is attached to the electric circular saw 210 when the coupling part 203 is inserted into the dust outlet port 212 that is a hollow cylinder integrally formed in the housing 213.

As shown in FIG. 1, the saw blade 214 cuts the workpiece 216 when the saw blade 214 is driven by the electric motor. The chips and residues generated during the cutting process move to the dust outlet port 212 by virtue of the inertia of the rotating saw blade 214 and an airflow generated by the rotating saw blade 214. The chips and residues are then guided together with the air from the coupling part 203 into the bag 230 in the box part 205.

After the chips and residues are guided together with air into the bag 230, only the air passes through the bag 230 and are released into the atmosphere through the windows 205a of the bag 230. The chips are accumulated in the bag 230. When the bag 230 is filled up with chips, the box part 205 is removed from the holding part 206 by an operator. The bag 230 is then taken out of the box part 205 and is discarded. Hence, the chips and residues are disposed of without being scattered around the electric circular saw 210.

To discard the bag 230 filled up with chips, however, the operator must first hold the dust collection unit 201 with one hand, and the electric circular saw 210 with the other hand. The operator then separates the dust collection unit 201 and the electric circular saw 210 from each other, grabs the box part 205 with both hands, and removes the box part 205 from the holding part 206. This is a cumbersome work for the operator to do.

To hold the bag 230 filled up with chips with one hand, the operator needs to place the coupling part 203 and holding part 206 temporarily at another place.

In order to solve the above problems, an object of the present invention is to provide a dust collection unit from which the collected chips and residues can be easily discarded with one hand. Another object of the present invention is to provide an electric tool having such a dust collection unit.

### SUMMARY OF THE INVENTION

The present invention provides a dust collection unit usable with an electric tool having an electric motor, an end tool driven by the electric motor, and a cover partially covering the end tool and having a residue discharge port. The dust collection unit is detachably communicable with the residue discharge port. The dust collection unit has a main casing, lid means, and a handle. The main casing is configured to accommodate dust and residues therein. The main casing has an opening. The lid means opens and closes the opening. The handle is provided in proximity to the lid means on the main casing.

The present invention further provides an electric tool having an electric motor, an end tool driven by the electric motor, a cover partially covering the end tool and having a residue discharge port, a dust collection unit detachably attached to the residue discharge port. The dust collection unit has a main casing, lid means, and a handle. The main casing is configured to accommodate dust and residues therein. The main casing has an opening. The lid means opens and closes the opening. The a handle is provided in proximity to the lid means on the main casing.

### BRIEF DESCRIPTION OF THE DRAWINGS

The aforementioned aspects and other features of the invention are explained in the following description, taken in connection with the accompanying drawing figures wherein:

FIG. 1 is a side view of a conventional electric circular saw having a dust-collecting unit;

FIG. 2 is a side view showing a miter saw according to an embodiment of the present invention;

FIG. 3 is a side view showing a dust collection unit;

FIG. 4 is a perspective view showing a part of the dust collection unit;

FIG. 5 is a plan view showing a structure of a frame member and a base member;

FIG. 6 is a perspective view showing the dust collection unit with a lid being open;

FIG. 7 is a view illustrating a way to throw chips and residues away into a garbage bag; and

FIG. 8 is an exploded view showing another structure of a dust collection unit.

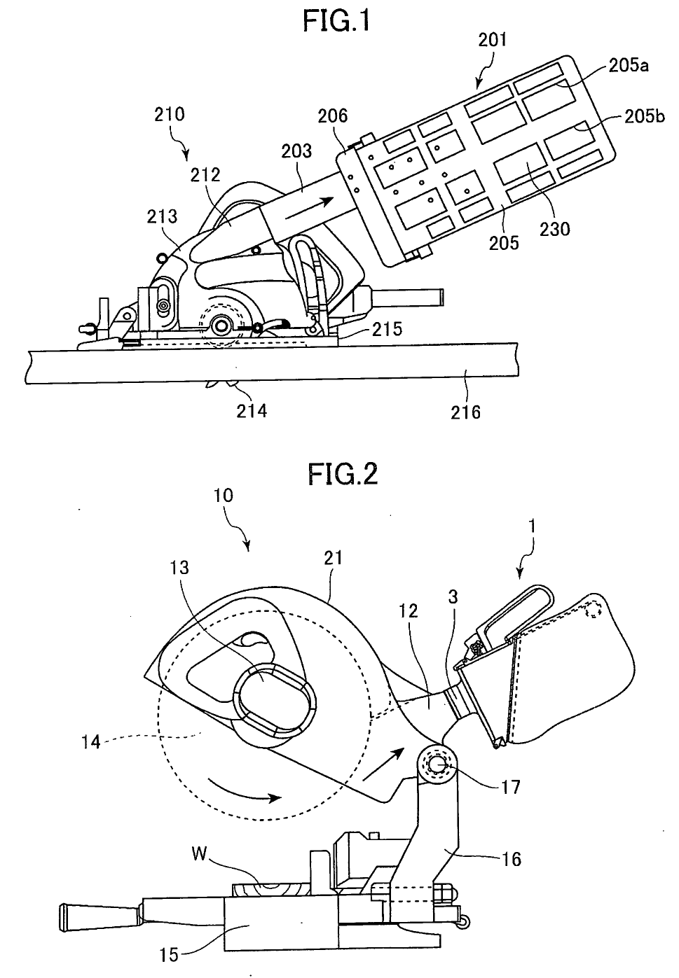

### DETAILED DESCRIPTION OF THE EMBODIMENTS

An embodiment of the present invention will be described, with reference to the accompanying drawings. In the drawings, like elements are identified by the same reference numerals, with duplications of an element in the same figure identified by subscripted reference numerals.

Referring to FIG. 2, a the miter saw 10 includes a table 15, a housing 13, and a circular saw blade 14. The table 15 has a stand 16 to support the housing 13. The housing 13 is pivotable about a rotary shaft 17 provided at an upper end of the stand 16. The housing 13 accommodates an electric motor (not shown) to rotate the saw blade 14. The housing 13 includes a saw cover 21 for covering an upper half of the saw blade 14. The circular saw blade 14 is pivotably movable together with the housing 13 about the shaft 17 to cut a workpiece W such as a wooden block carried on the table 15.

The saw cover 21 has a dust ejection port 12 facing an outer edge of the saw blade 14. A dust collection unit 1 is detachably attached to the dust ejection port 12 to be in fluid communication with the inside of the saw cover 21.

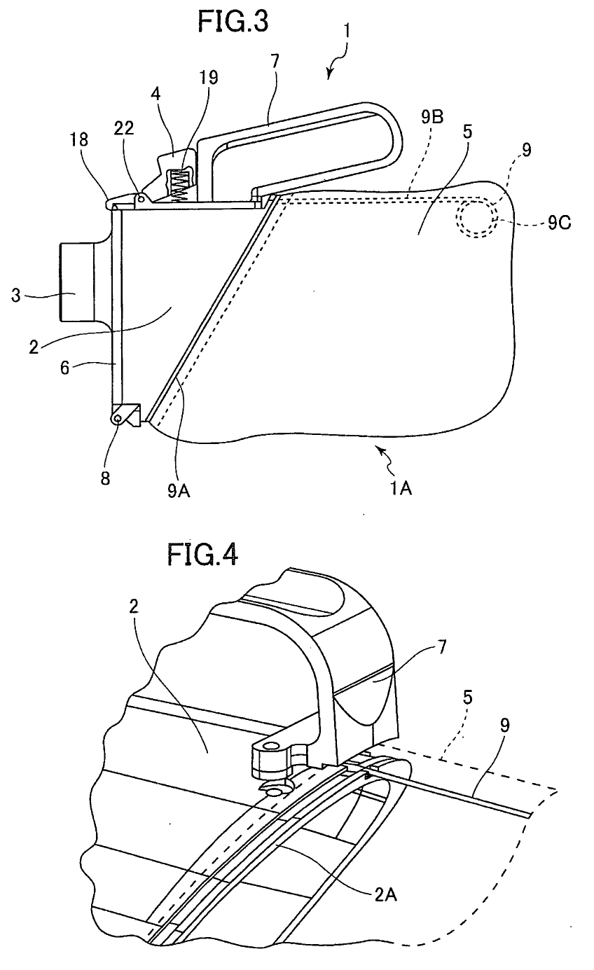

Referring to FIG. 3, the dust collection unit 1 includes a main casing 1A and a lid 6. The main casing 1A has a base member 2 and a filter member 5 attached to the base member 2.

The base member 2 has a tubular shape having a cylindrical or rectangular cross section along an imaginary tubular axis. The base member 2 is made from a transparent or translucent synthetic resin such as acrylic resin. The base member 2 has two open ends. As shown in FIG. 6, one of the two open ends is formed as a dust ejection port 20. A handle 7 is provided on the outer side surface of the base member 2. The lid 6 is configured to open and close the dust ejection port 20.

The lid 6 is made from a resin and has the same shape as the cross section of the base member 2. A coupling cylinder 3 is formed integral with the lid 6. The coupling cylinder 3 has an inside diameter which is greater than the outside diameter of the dust ejection port 12. Accordingly, the coupling cylinder 3 is removably fitted to the dust ejection port 12, as shown in FIG. 2. When the dust ejection port 12 is connected with the coupling cylinder 3, the dust collection unit 1 is in fluid communication with the inside of the saw cover 21 through the coupling cylinder 3.

The lid 6 is pivotably coupled to the one open end 20 of the main casing 1A through a hinge 8 in order to open and close the dust ejection port 20 of the main casing 1A. The hinge 8 is provided on the opposite side to the handle 7. A torsion coil spring (not shown) is wound around the hinge 8 to urge the lid 6 to rotate in a direction away from the dust ejection port 20.

The filter member 5 is made of a flexible bag with an open end being fold back. The filter member 5 is removably attached to the other open end 2A of the base member 2. In this embodiment, the other open end 2A is open in a direction slanted from the imaginary tubular axis. The filter member 5 is made from Japanese paper, fabrics, and synthetic fibers such as any material having a mesh that allows only air to pass.

The filter member 5 contains a wire frame 9 to maintain the filter member 5 in a developed shape. As shown in FIGS. 3 and 4, the wire frame 9 has a circular portion 9A and a linear portion 9B.

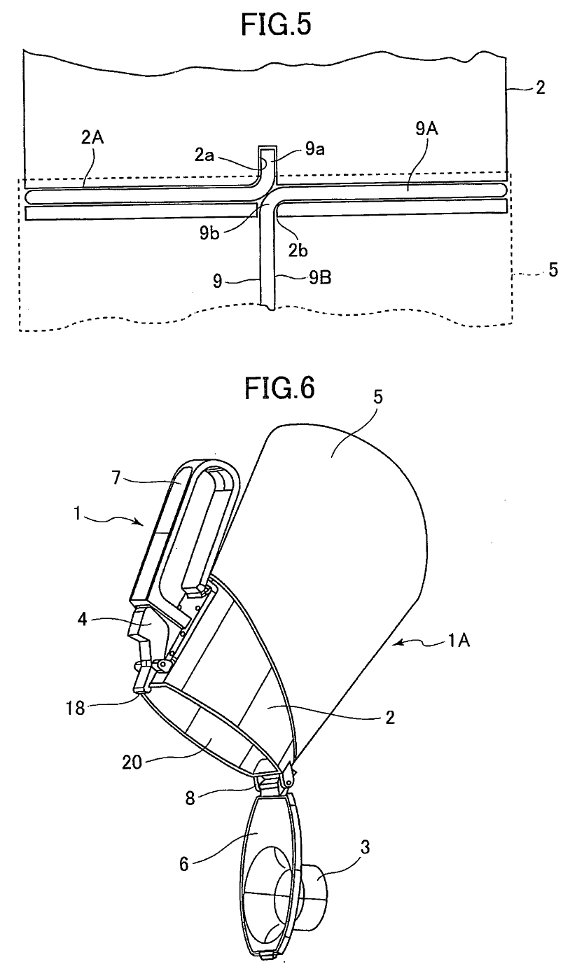

The linear portion 9B is inserted inside of the filter member 5 and the circular portion 9A is accommodated in the folded open end of the filter member 5. The wire frame 9 with the filter member 5 is then fitted in a groove 2A formed around the outer surface of the other open end of the base member 2 so that the filter member 5 is attached and fixed to the base member 2 by means of the wire frame 9. At this time, as shown in FIG. 5, one end 9a of the circular portion 9A is bent in the shape of L and fitted in a small groove 2a extending from the groove 2A at a right angel through the filter member 5. A proximal end 9b of the linear portion 9B is bent substantially at a right angle with respect to the circular portion 9A and fitted in a groove 2b extending from the groove 2A to the other open end of the base member 2.

The linear portion 9B has a length in a manner that the other end 9c thereof nearly reaches the bottom of the filter member 5 (to the right in FIG. 3). The other end 9c is looped to avoid any damage to the filter member 5. As shown in FIG. 4, after the filter member 5 is attached to the base member 2 by the wire frame 9 which has been fitted in the groove 2A and the small grooves 2a and 2b, the handle 7 is attached to the base member 2 by screws (not shown) so as to sandwich the ends 9a and 9b with the base member 2. Thus, the wire frame 9 is readily secured to the base member 2.

Referring to FIG. 3, a drive mechanism 4 is provided near the handle 7 on the outer surface of the base member 2. The drive mechanism 4 operates the lid 6 to open and close the dust ejection port 20. The drive mechanism 4 has an engaging element 18 that is rotatable around a shaft 22 provided on the outer surface of the base member 2. In other words, the drive mechanism 4 closes the dust ejection port 20 with the lid 6, as shown in FIG. 3, when the engaging element 18 is engaged with a peripheral edge of the lid 6. The drive mechanism 4 releases the lid 6 and opens the dust ejection port 20, when the engaging element 18 is disengaged with the peripheral edge of the lid 6. A return spring 19 is provided between the engaging element 18 and the base member 2 so as to bias the engaging element 18 to maintain the engaged condition with the peripheral edge of the lid 6.

As described above, the lid 6, the engaging element 18, and the return spring 19 constitute the drive mechanism 4 for opening and closing the dust ejection port 20. The engaging element 18 and the return spring 19 are located in the vicinity of the handle 7. And an operator can manipulate this mechanism with one hand.

The dust collection unit 1 having the above structure is attached to the miter saw 10 as shown in FIG. 2 by fitting the coupling cylinder 3 of the lid 6 into the dust ejection port 12 of the miter saw 10. Accordingly, the dust collection unit 1 functions to collect chips and residues generated from the workpiece 16 when the miter saw 1 is operating.

The next description will be made for explaining an operation of the miter saw 10. To cut the workpiece W with the miter saw 10, the saw blade 14 is first driven by the electric motor to rotate in the direction of the arrow shown in FIG. 2. And the saw blade 14 is then pushed down with the housing 13 about the shaft 17, the saw blade 14 cuts the workpiece 16. Chips and residues generated from the workpiece W during the cutting process are moved in the direction of the arrow shown in FIG. 2 in the saw cover 21 due to an inertial force and an air stream generated by the rotation of the saw blade 14. The chips and residues are then carried into the dust collection unit 1 through the dust ejection port 12.

The dust collection unit 1 collects the chips and residues coming into the main casing 1A through the coupling cylinder 3. The air including the chips and residues and introduced into the main casing 1A passes through the filter member 5 so that the only air is discharged into the atmosphere. Therefore, only the chips and residues are accumulated in the main casing 1A. In this embodiment, the coupling cylinder 3 integral with the lid 6 faces the filter member 5 during the operation of the miter saw 10 so that this structure assists to separate the chips and residues from the efficiently.

In order to throw out the chips and residues in the main casing 1A, the operator holds the handle 7 with one hand and detaches the dust collection unit 1 from the miter saw 10. More precisely, the operator pulls the entire dust collection unit 1 from the miter saw 10 and releases the engagement of the coupling cylinder 3 with the dust ejection port 12. Thus, the dust collection unit 1 is detached from the miter saw 10.

The operator then holds the dust collection unit 1 with one hand and carries the same to the place where the chips and residues can be discarded. In this embodiment, the base member 2 is transparent or translucent so that the chips and residues accumulated in the main casing 1A are visible from outside. Therefore, the operator easily determines when the chips and residues in the main casing 1A should be discarded.

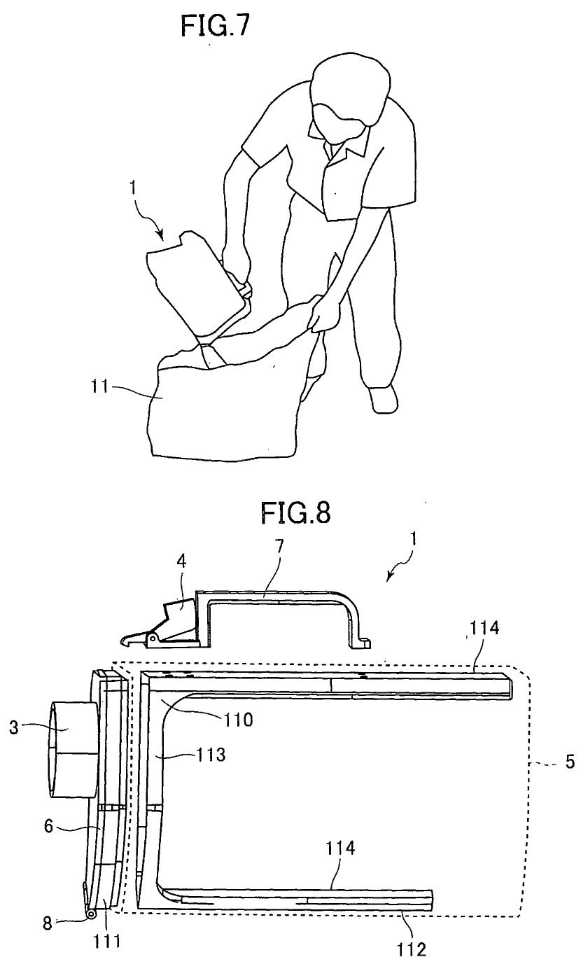

When the chips and residues are discarded, the operator fist pushes the drive mechanism 4 against the bias force of the return spring 19, while holding the handle 7 with one hand. Then, the engaging element 18 is released from the peripheral edge of the lid 6 so that the lid 6 rotates about the hinge 8 by virtue of the elastic force of the torsion coil spring provided at the hinge 8. Accordingly, the dust ejection port 20 is opened as shown in FIG. 6. Then, as shown in FIG. 7, the operator maintains holding the dust collection unit 1 with one hand, while treating a garbage bag 11 with the other hand. When the operator turns the main casing 1A upside down in order to face the dust ejection port 20 to the inside of the garbage bag 11, the chips falls from the main casing 1A into the garbage bag 11 through the dust ejection port 20. As described above, the operator can discard the chips and residues into the bag 11 easily with the only one hand. Accordingly, the disregarding process for the chips and residues can be easily performed efficiently.

After discarding the chips and residues from the dust collection unit 1 into the garbage bag 11, the operator pivots the lid 6 about the hinge 8 to close the dust ejection port 20 with the lid 6. The engaging element 18 is then engaged with the peripheral edge of the lid 6 to maintain the closing condition of the lid 6, as illustrated in FIG. 3. When the operator again attaches the dust collection unit 1 to the miter saw 10, as shown in FIG. 2, the operator cuts the workpiece again by the miter saw 10.

In this embodiment, the main casing 1A has the base member 2 made of resin and the filter member 5 made of a soft bag attached to the base member 2. If the dust collection unit 1 attached to the miter saw 10 is bumped against a wall during a transport of the miter saw 10, the filter member 5 may deform to absorb an impact of the bump, thereby preventing both the dust collection unit 1 and the miter saw 10 from being damaged.

As described above, the wire frame 9 assists in maintaining the filter member 5 in the developed shape, when the miter saw 10 is operated and when the dust collection unit 1 is disconnected from the miter saw 10. Accordingly, dusts and residues from the workpiece can be reliably collected and discarded.

With the above structure to fix the wire frame 9 to the base member 2, the wire frame 9 can be firmly and reliably fixed to the base member 2. The wire frame 9 does not slip off from the base member 2 during the use of the dust collection unit 1. Thus, the filter member 5 can maintain the original bag shape at any time.

The wire frame 9 may be removed to form the dust collection unit 1. FIG. 8 shows another embodiment of a base member 110 for the dust collection unit 1. In this embodiment, the base member 110 is constituted by a ring frame 111 and a support frame 112 which is detachably fitted to one open end of the ring frame 111. Both of the ring frame 111 and the support frame 112 are made of resin.

The lid 6 is pivotably provided to the ring frame 111 with the hinge 8. The support frame 112 has a ring portion 113 and a pair of bar portions 114, 114. The bar portions 114, 114 extends from two positions of the ring member 113, which are opposed to each other on an open end of the ring portion 113, toward the bottom of the filter member 5, respectively.

The support frame 112 is inserted in the filter member 5, while a rim of the filter member 5 is folded back so as to sheathe the ring portion 113. The support frame 112 is then fitted to the ring frame 111. The handle 7 is then attached and fixed to the bar portion 114 by screws from above the filter member 5 so that the drive mechanism 4 is detachably engaged with the rim of the lid 6 on the opposite side of the hinge 8.

The advantages of the second embodiment of the dust collection unit 1 having the base member 110 are the same as those of the first embodiment.

As described above, when the dust collection unit is filled up with dust, the operator may hold the handle with one hand, remove the dust collection unit from the electric tool, and manipulate the drive mechanism provided near the handle with the same hand to open the dust ejection port easily. The operator can therefore discard the dust from the dust collection unit easily and efficiently, using only one hand.

The main casing 1A is made of transparent or translucent material so that the operator can look at the inside of the main casing 1A. That is, the dust and residues accumulated in the main casing 1A can be clearly seen from outside. Hence, the operator can know well when the dust should be discarded from the dust collection unit.

To discard the dust and residues from the dust collection unit 1, the operator only needs to operate the drive mechanism 4 with one hand, releasing the lid 6 and thereby opening the dust ejection port 20. This helps to enhance the efficiency of discarding the dust and residues through the dust ejection port 20.

The coupling cylinder through which the chips and air flow pass faces the filter member for separating the chips from the air. This helps to separate the chips from the air at high efficiency.

When the drive mechanism is operated with one hand to disengage the engaging element 18 from the lid 6, the lid 6 automatically rotates by virtue of the bias force of the spring to open the dust ejection port 20. The dust and residues can be easily discarded from the dust collection unit 1.

When the engaging element 18, which is provided near the handle 7, is operated against the bias of the return spring 19, the engaging element 18 is released from the lid 6. As a result, the dust ejection port 20 is opened. Therefore, the operator can efficiently discard the dust and residues from the dust collection unit 1, using only one hand.

The main casing 1A includes the base member 2 and the filter member 5 that is a soft bag and attached to the base member 2. Because the base member 2 and the filter member 5 are soft, the filter member 5 may deform if the dust collection unit 1 bumps on a wall during the transport of the electric tool 10 with the dust collection unit 1. This structure prevents both of the dust collection unit 1 and the electric tool 10 from being damaged.

The filter member 5 contains the wire frame 9 for maintaining the filter member 5 in a developed shape. Since the filter member 5 remains in the form of a bag when the dust is collected and when the dust is discarded. This structure helps to collect and discard the dust reliably.

Since the wire frame 9 is secured to the base member 2, the filter member 5 can be prevented from accidentally being released from the base member 2. In other words, the wire frame 9 does not slip off from the base member 2 during the use of the dust collection unit 1.

The present invention is applicable to any electric tools which need a dust collection unit for collecting dust and residues.

It is understood that the foregoing description and accompanying drawings set forth the embodiments of the invention at the present time. Various modifications, additions and alternative designs will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

1. A dust collection unit usable with an electric tool comprising an electric motor, an end tool driven by the electric motor, and a cover partially covering the end tool and having a residue discharge port, the dust collection unit being detachably communicable with the residue discharge port, comprising:
a main casing configured to accommodate dust and residues therein, the main casing having an opening;
lid means for opening and closing the opening; and
a handle provided in proximity to the lid means on the main casing.

2. The dust collection unit as claimed in claim 1, wherein the main casing has at least one of a transparent portion and a translucent portion.

3. The dust collection unit as claimed in claim 1, wherein the lid means comprises:
a lid member for covering the opening; and
a drive mechanism for operating the lid member with respect to the opening.

4. The dust collection unit as claimed in claim 3, wherein the lid member is hinged to the opening.

5. The dust collection unit as claimed in claim 3, wherein the drive mechanism comprises:
an engaging member capable of being engaged with the lid member; and
resilient means for urging the engaging member to contact the lid member to the opening.

6. The dust collection unit as claimed in claim 1, wherein the lid means has a connection port connectable with the residue discharge port.

7. The dust collection unit as claimed in claim 1, wherein the main casing comprises:
a base member having a cylindrical shape and two open ends, one of the two open ends being the opening; and
a filter bag having an opening and being attachable to the base member.

8. The dust collection unit as claimed in claim 7, further comprising a frame member for holding the filter bag in a predetermined shape.

9. The dust collection unit as claimed in claim 8, wherein the frame member is fixed to the base member.

10. The dust collection unit as claimed in claim 8, wherein the frame member is made from a wire, one end of the frame member is attached to one open end of the base member, and the handle is attached to the base member so as to enhance the attachment of the frame member to the base member.

11. An electric tool comprising:
an electric motor;
an end tool driven by the electric motor;
a cover partially covering the end tool and having a residue discharge port; and
a dust collection unit detachably attached to the residue discharge port,
the dust collection unit comprising:
a main casing configured to accommodate dust and residues therein, the main casing having an opening;
lid means for opening and closing the opening; and
a handle provided in proximity to the lid means on the main casing.

12. The electric tool as claimed in claim 11, wherein the main casing has at least one of a transparent portion and a translucent portion.

13. The electric tool as claimed in claim 11, wherein the lid means comprises:
a lid member for covering the opening; and
a drive mechanism for operating the lid member with respect to the opening.

14. The electric tool as claimed in claim 13, wherein the lid member is hinged to the opening.

15. The electric tool as claimed in claim 13, wherein the drive mechanism comprises:
an engaging member capable of being engaged with the lid member; and
resilient means for urging the engaging member to contact the lid member to the opening.

16. The electric tool as claimed in claim 11, wherein the lid means has a connection port connectable with the residue discharge port.

17. The electric tool as claimed in claim 11, wherein the main casing comprises:
a base member having a cylindrical shape and two open ends, one of the two open ends being the opening; and
a filter bag having an opening and being attachable to the base member.

18. The electric tool as claimed in claim 17, further comprising a frame member for holding the filter bag in a predetermined shape.

19. The electric tool as claimed in claim 18, wherein the frame member is fixed to the base member.

20. The electric tool as claimed in claim 18, wherein the frame member is made from a wire, one end of the frame member is attached to one open end of the base member, and the handle is attached to the base member so as to enhance the attachment of the frame member to the base member.
